(19) United States
(12) Patent Application Publication
(10) Pub. No.: US 2016/0219558 A1
(43) Pub. Date: Jul. 28, 2016

(54) LOW OVERHEAD SIGNALING FOR POINT TO MULTIPOINT NLOS WIRELESS BACKHAUL

(71) Applicant: TEXAS INSTRUMENTS INCORPORATED, Dallas, TX (US)

(72) Inventors: PIERRE BERTRAND, Antibes (FR); JUNE CHUL ROH, Allen, TX (US); JUN YAO, Shanghai (CN)

(73) Assignee: TEXAS INSTRUMENTS INCORPORATED, DALLAS, TX (US)

(21) Appl. No.: 14/817,640

(22) Filed: Aug. 4, 2015

Related U.S. Application Data
(60) Provisional application No. 62/106,594, filed on Jan. 22, 2015.

(51) Int. Cl. H04W 72/04; H04L 1/00; H04W 74/08

(52) U.S. Cl. CPC H04W 72/042; H04W 74/0833; H04L 1/004

(57) ABSTRACT

A method of operating a wireless communication system is disclosed. The method includes receiving allocation information for a plurality of second wireless transceivers from a first wireless transceiver by one of the second wireless transceivers on a physical broadcast channel (PBCH). The one of the second wireless transceivers decodes the allocation information for the plurality of second wireless transceivers. The one of the second wireless transceivers receives procedural information on a physical downlink control channel (PDCCH) in response to the decoded allocation information

This application claims the benefit under 35 U.S.C. §119(e) of Provisional Appl. No. 62/106,594, filed Jan. 22, 2015 (TI-75797PS), which is incorporated herein by reference in its entirety.

### BACKGROUND OF THE INVENTION

Embodiments of the present invention relate to wireless communication systems and, more particularly, to low overhead control signaling of a Non-Line-Of-Sight (NLOS) wireless communication system compatible with a time-division duplex long term evolution (TD-LTE) Radio Access Network (RAN).

A key answer to the huge data demand increase in cellular networks is the deployment of small cells providing Long Term Evolution (LTE) connectivity to a smaller number of users than the number of users typically served by a macro cell. This allows both providing larger transmission/reception resource opportunities to users as well as offloading the macro network. However, although the technical challenges of the Radio Access Network (RAN) of small cells have been the focus of considerable standardization effort through 3GPP releases 10-12, little attention was given to the backhaul counterpart. It is a difficult technological challenge, especially for outdoor small cell deployment where wired backhaul is usually not available. This is often due to the non-conventional locations of small cell sites such as lamp posts, road signs, bus shelters, etc., in which case wireless backhaul is the most practical solution.

The LTE wireless access technology, also known as Evolved Universal Terrestrial Radio Access Network (E-UTRAN), was standardized by the 3GPP working groups. OFDMA and SC-FDMA (single carrier FDMA) access schemes were chosen for the DL and UL of E-UTRAN, respectively. User equipments (UEs) are time and frequency multiplexed on a physical uplink shared channel (PUSCH) and a physical uplink control channel (PUCCH), and time and frequency synchronization between UEs guarantees optimal intra-cell orthogonality. The LTE air-interface provides the best spectral-efficiency and cost trade-off of recent cellular networks standards, and as such, has been vastly adopted by operators as the unique 4G technology for the Radio Access Network (RAN), making it a robust and proven technology. As the tendency in the RAN topology is to increase the cell density by adding small cells in the vicinity of a legacy macro cells, the associated backhaul link density increases accordingly and the difference between RAN and backhaul wireless channels also decreases. This also calls for a point-to-multipoint (P2MP) backhaul topology. As a result, conventional wireless backhaul systems typically employing single carrier waveforms with time-domain equalization (TDE) techniques at the receiver become less practical in these environments. This is primarily due to their limitation of operating in point-to-point line-of-sight (LOS) channels in the 6-42 GHz microwave frequency band. On the contrary, the similarities between the small cell backhaul and small cell access topologies (P2MP) and wireless radio channel (NLOS) naturally lead to use a very similar air interface.

There are several special issues associated with NLOS backhaul links at small cell sites, such as a requirement for high reliability with a packet error rate (PER) of 10⁻⁶, sparse spectrum availability, critical latency, cost, with, on the other hand, relaxed peak-to-average power ratio (PAPR). Behavior of NLOS backhaul links at small cell sites also differs from RAN in that there is no handover, remote units do not connect and disconnect at the same rate as user equipment (UE), and the NLOS remote unit (RU) at the small cell site is not mobile.

While preceding approaches provide improvements in backhaul transmission in a wireless NLOS environment, the present inventors recognize that still further improvements are possible. Accordingly, the preferred embodiments described below are directed toward this as well as improving upon the prior art.

### BRIEF SUMMARY OF THE INVENTION

In a first embodiment of the present invention, there is disclosed a method of operating a wireless communication system. The method includes receiving allocation information for a plurality of second wireless transceivers from a first wireless transceiver by one of the second wireless transceivers on a physical broadcast channel (PBCH). The one of the second wireless transceivers decodes the allocation information and receives procedural information on a physical downlink control channel (PDCCH) in response to the decoded allocation information.

In a second embodiment of the present invention, there is disclosed a method of operating a first wireless transceiver. The method includes determining a frame configuration for a frame having a plurality of slots and determining a slot number of one of the slots. The method further includes determining a number of second wireless transceivers supported by the first wireless transceiver. A physical uplink control channel (PUCCH) size is allocated in response to the frame configuration, the slot number, and the number of second wireless transceivers.

In a third embodiment of the present invention, there is disclosed a method of operating a first wireless transceiver. The method includes transmitting system information and at least one scheduling grant in a transport block (TB) to a plurality of second wireless transceivers on a physical broadcast channel (PBCH). The first wireless transceiver subsequently receives one of an acknowledgement (ACK) and negative acknowledgement (NACK) from each second wireless transceiver.

### BRIEF DESCRIPTION OF THE SEVERAL VIEWS OF THE DRAWING

FIG. 1 is a diagram of a wireless communication system with a cellular macro site hosting a backhaul point to multipoint (P2MP) hub unit (HU) serving plural remote units (RUs) which relay communications between small cells and plural user equipment (UE);

FIG. 2 is a diagram of downlink and uplink subframe configurations according to the present invention;

FIG. 3 is a diagram of a subset of downlink and uplink subframe configurations of the prior art;

FIG. 4 is a diagram of a subset of downlink and uplink slot configurations according to the present invention;

FIG. 5 is a detailed diagram of a data frame as in configuration 3 (FIG. 2) showing downlink and uplink slots and a special slot;

FIG. 6 is a diagram of a downlink (DL) slot that may be used in the data frame of FIG. 5 according to the present invention;

FIG. 7 is a diagram of an uplink (UL) slot that may be used in the data frame of FIG. 5 according to the present invention;

FIG. 8 is a diagram showing communication of system information between a HU and a RU over a physical broadcast channel (PBCH);

FIG. 9A is a diagram showing physical broadcast channel (PBCH) operational procedure at an RU; and

FIG. 9B is a diagram showing physical broadcast channel (PBCH) operational procedure at an HU.

### DETAILED DESCRIPTION OF THE INVENTION

Some of the following abbreviations are used throughout the instant specification. The following glossary provides an alphabetical explanation of these abbreviations.

BLER: Block Error Rate

CQI: Channel Quality Indicator

CRS: Cell-specific Reference Signal

CSI: Channel State Information

CSI-RS: Channel State Information Reference Signal

DCI: Downlink Control Information

DL: DownLink

DwPTS: Downlink Pilot Time Slot

eNB: E-UTRAN Node B or base station or evolved Node B

EPDCCH: Enhanced Physical Downlink Control Channel

E-UTRAN: Evolved Universal Terrestrial Radio Access Network

FDD: Frequency Division Duplex

HARQ: Hybrid Automatic Repeat Request

HU: (backhaul) Hub Unit

ICIC: Inter-cell Interference Coordination

LTE: Long Term Evolution

MAC: Medium Access Control

MIMO: Multiple-Input Multiple-Output

MCS: Modulation Control Scheme

OFDMA: Orthogonal Frequency Division Multiple Access

PCFICH: Physical Control Format Indicator Channel

PAPR: Peak-to-Average Power Ratio

PDCCH: Physical Downlink Control Channel

PDSCH: Physical Downlink Shared Channel

PMI: Precoding Matrix Indicator

PRB: Physical Resource Block

PRACH: Physical Random Access Channel

PS: Pilot Signal

PUCCH: Physical Uplink Control Channel

PUSCH: Physical Uplink Shared Channel

QAM: Quadrature Amplitude Modulation

RAR: Random Access Response

RE: Resource Element

RI: Rank Indicator

RRC: Radio Resource Control

RU: (backhaul) Remote Unit

SC-FDMA: Single Carrier Frequency Division Multiple Access

SPS: Semi-Persistent Scheduling

SRS: Sounding Reference Signal

TB: Transport Block

TDD: Time Division Duplex

TTI: Transmit Time Interval

UCI: Uplink Control Information

UE: User Equipment

UL: UpLink

UpPTS: Uplink Pilot Time Slot

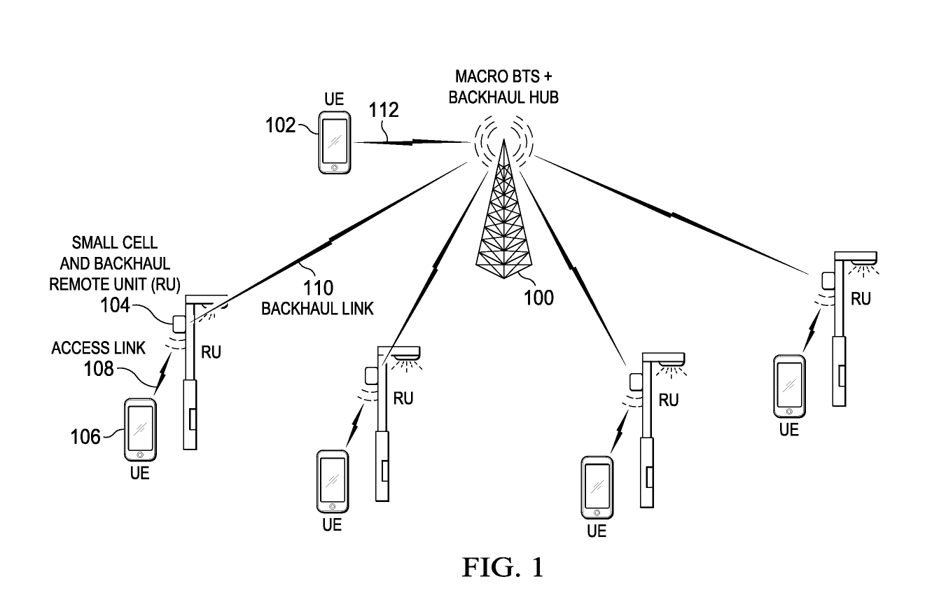

Referring to FIG. 1, there is a NLOS Time Division Duplex (TDD) wireless backhaul system according to the present invention. Cellular macro site 100 hosts a macro base station. Macro site 100 also hosts a co-located small cell base station and wireless backhaul hub unit (HU). Macro site 100 has small cell sites such as small cell site 104. Each small cell site is co-located with a small cell base station and wireless backhaul remote unit (RU). Macro site 100 communicates with the small cell sites through a point-to-multipoint (P2MP) wireless backhaul system via backhaul links such as backhaul link 110. The base station of macro site 100 communicates directly with UE 102 over RAN link 112. UE 106, however, communicates directly with the small cell base station of small cell site 104 over a RAN access link 108. The RU of small cell site 104, in turn, communicates directly with the HU of macro cell site 100 over a backhaul link 110. The system is designed to maximize spectrum reuse. The backhaul link 110 design utilizes a 0.5 ms slot-based transmission time interval (TTI) to minimize latency and 5 ms UL and DL frames for compatibility with TD-LTE. Thus, various UL/DL ratios are compatible with TD-LTE configurations. This allows flexible slot assignment for multiple Remote Units (RUs).

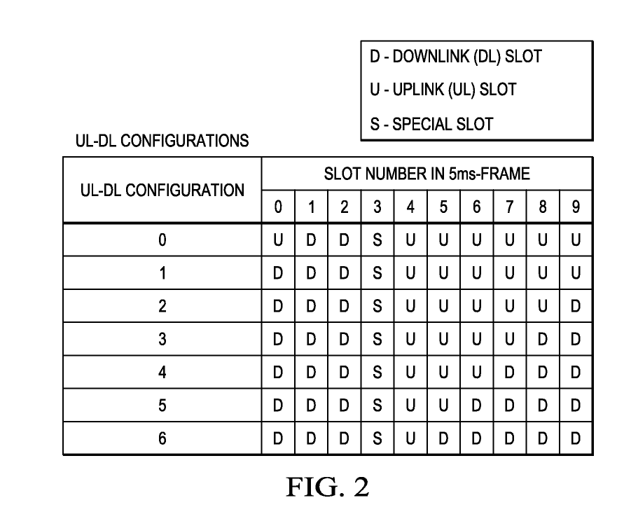

FIG. 2 shows the TDD frame structure of the present invention, with seven uplink (UL) and downlink (DL) frame configurations, thus supporting a diverse mix of UL and DL traffic ratios. Each configuration includes various uplink (U), downlink (D), and special (S) slots, each having a 0.5 ms duration transmit time interval (TTI) for a total frame duration of 5 ms. In one embodiment, this frame structure is utilized to generate an NLOS backhaul link 110 of FIG. 1. However, the present invention may be used to generate any kind of communication link sharing similar co-existence with TD-LTE and performance requirements as the NLOS backhaul link. As a result, without loss of generality the frame structure and associated components (slots, channels, etc. . . . ) of the present invention are referred to as “NLOS backhaul” or simply “NLOS” frame, slots, channels, etc.

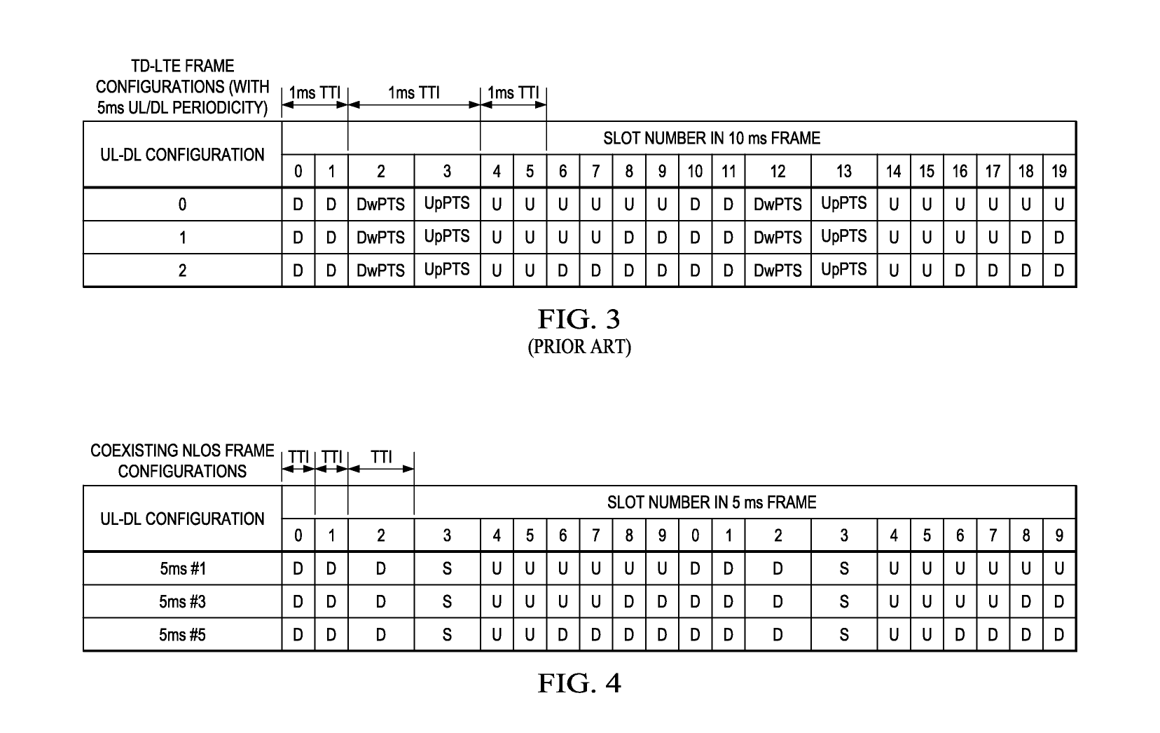

Referring now to FIG. 3, the frame structure of a 10 ms TD-LTE frame of the prior art will be compared to a 5 ms TDD frame (FIG. 4) of the present invention. FIG. 4 is a more detailed view of UL/DL frame configurations 1, 3 and 5 as shown at FIG. 2. The frame of FIG. 3 is divided into ten subframes, each subframe having a 1 ms TTI. Each subframe is further divided into two slots, each slot having a 0.5 ms duration. Thus, there are twenty slots (0-19) in each TD-LTE configuration. A D in a slot indicates it is a downlink slot. Correspondingly, a U in a slot indicates it is an uplink slot. Time slots 2 and 3 constitute a special subframe allowing transitioning from a DL subframe to an UL subframe. DwPTS and UpPTS indicate downlink and uplink portions of the special subframe, respectively.

By way of comparison, the frame of FIG. 4 of the present invention has a 5 ms duration and is slot based rather than subframe based. Each frame has ten (0-9) slots. Each slot has a 0.5 ms duration. As with the frame of FIG. 3, D indicates a downlink slot, and U indicates an uplink slot. In each of the three UL/DL configurations of FIG. 4, however, slots 3 of both frames include a special slot indicated by an S, rather than the special subframes in slots 2-3 and 12-13 of FIG. 3. This fixed location of the special slot assures compatibility with TD-LTE frames. It advantageously permits always finding an NLOS UL/DL configuration that is 100% compatible with any 5 ms period TD-LTE UL/DL subframe configuration. For example, this prevents an NLOS backhaul DL transmission from interfering with a TD-LTE RAN UL transmission on an access link when both operate on the same frequency. In other words, it advantageously prevents the transmitter at macro cell site 100 of one system from interfering with the receiver of a co-located system.

The frame configurations of FIG. 4 have several features in common with the frame configurations of FIG. 3 to assure compatibility when operating at the same frequency. Both frames have 0.5 ms slot duration with seven SC-FDMA symbols and a normal cyclic prefix (CP) in each slot. The SC-FDMA symbol duration is the same in each frame. Both frames have the same number of subcarriers for respective 5 MHz, 10 MHz, 15 MHz, and 20 MHz bandwidths, and both have 15 kHz subcarrier spacing. Both frames use the same resource element (RE) definition and support 4, 16, and 64 QAM encoding.

The frame configuration of FIG. 4 has several unique features. The symbols of each slot are primarily SC-FDMA for both UL and DL. The first SC-FDMA symbol of each slot includes a pilot signal (PS) to improve system latency. A cell-specific sync signal (SS) different from the PS is included in each frame for cell search and frame boundary detection.

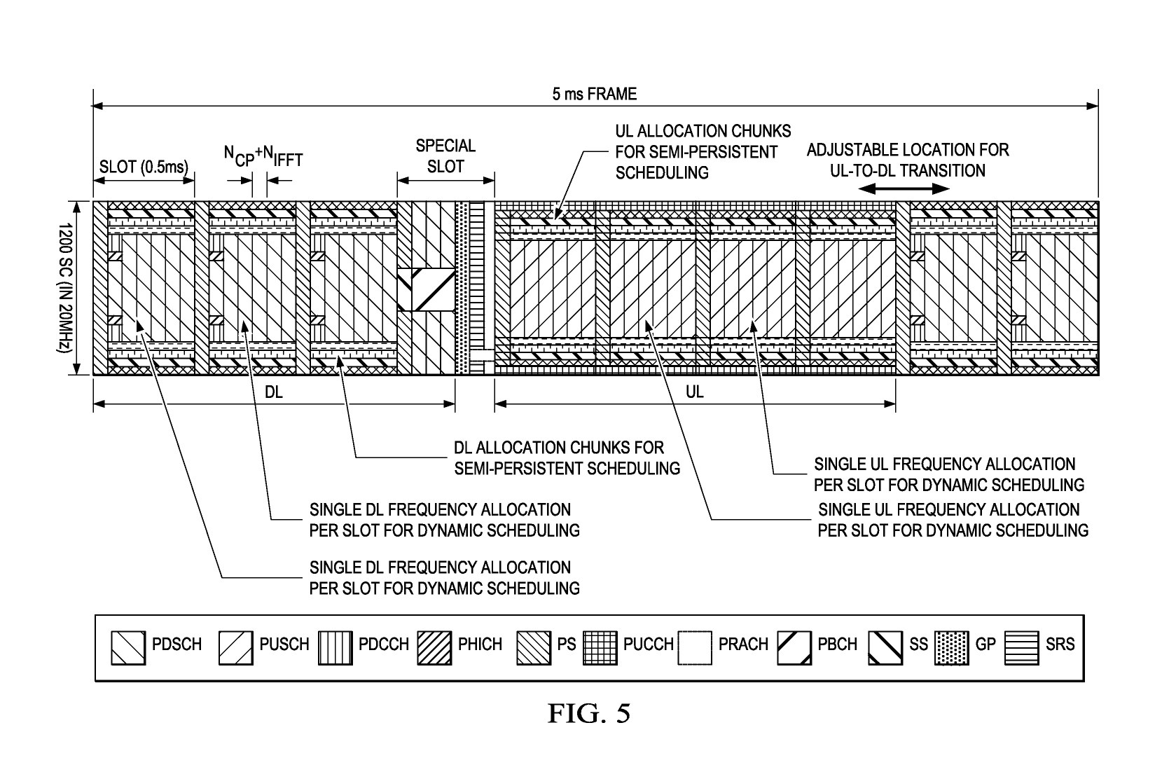

Referring now to FIG. 5, there is a detailed diagram of an NLOS backhaul (BH) frame as shown in UL/DL configuration 3 of FIG. 4. Here and in the following discussion, the vertical axis of the diagram indicates frequencies of component carriers, and the horizontal axis indicates time, where each slot has 0.5 ms duration. For example, a slot having a 20 MHz bandwidth includes 1200 subcarriers (SC) having a carrier spacing of 15 kHz. The frame includes DL slots, a special slot, and UL slots. Each DL and UL slot has seven respective single carrier frequency division multiple access (SC-FDMA) symbols. Each symbol is indicated by a separate vertical column of the slot.

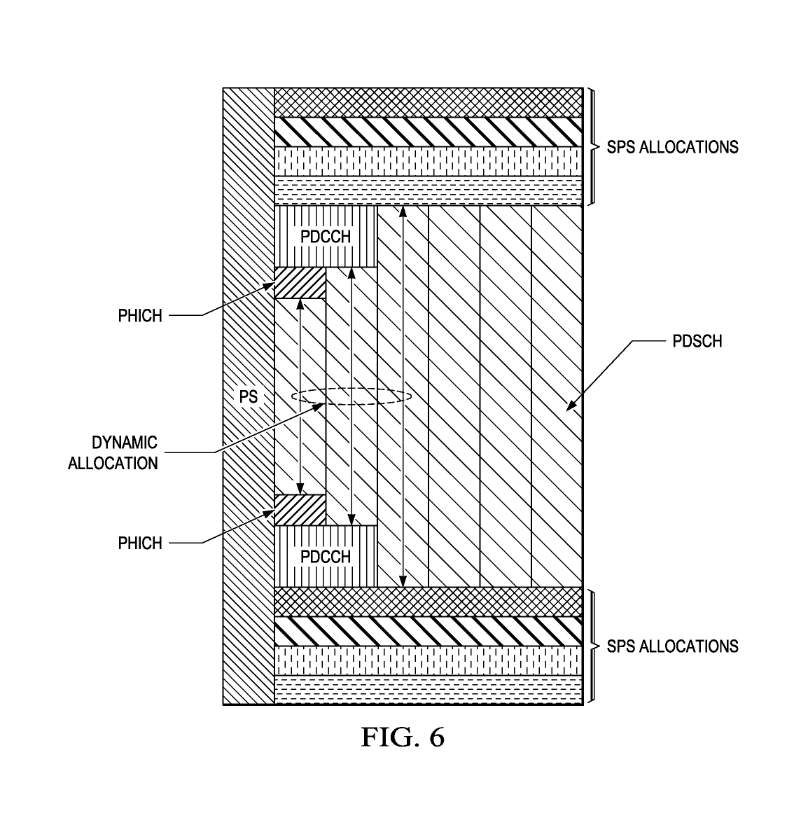

Referring to FIG. 6, there is a detailed diagram of a downlink slot that may be used with the frame of FIG. 5. DL slots are used for transmitting the Physical Downlink Shared Channel (PDSCH) conveying payload traffic from the HU to the RUs. The DL slot includes dynamic and semi-persistent scheduling (SPS) regions as directed by Medium Access Control (MAC) signaling. Dynamic scheduling allocates resources based on RU feedback about the link condition. This achieves flexible resource allocation at the cost of increased control signaling that may hinder packet delivery. Semi-persistent scheduling allocates packets for a fixed future time. This advantageously provides flexible resource allocation with fewer control signals. With the exception of special slots, the DL slot also contains the Physical HARQ Indicator Channel (PHICH) conveying HARQ ACK/NACK feedback to the RU. The Physical Downlink Control Channel (PDCCH) is also transmitted in this slot. The PDCCH provides the RU with PHY control information for MCS and MIMO configuration for each dynamically scheduled RU in that slot. The PDCCH also provides the RU with PHY control information for MCS and MIMO configuration for each dynamically scheduled RU in one or more future UL slots.

In order to improve the latency for high priority packets, four pairs of spectrum allocations at both ends of the system bandwidth may be assigned to different RUs, where the frequency gap between the two allocation chunks of a pair is the same across allocation pairs. The resource allocation is done in a semi-persistent scheduling (SPS) approach through a dedicated message from higher layers in the PDSCH channel. The size of each SPS allocation pair is configurable depending on expected traffic load pattern. For example, no physical resource blocks (PRBs) are allocated for SPS transmission when there is no SPS allocation. With greater expected traffic, either two (one on each side of the spectrum) or four (two on each side of the spectrum) PRBs may be allocated. Each RU may have any SPS allocation or multiple adjacent SPS allocations. In one embodiment, all four SPS allocation pairs are the same size. Most remaining frequency-time resources in the slot, except for PS, PDCCH, PHICH, and SPS allocations, are preferably dynamically assigned to a single RU whose scheduling information is conveyed in the PBCH.

Similar to LTE, in order to minimize the complexity, all allocation sizes are multiples of PRBs (12 subcarriers) and are restricted to a defined size set. The only exception is for SPS allocations that may take the closest number of sub-carriers to the nominal targeted allocation size (2 or 4 PRBs). This minimizes the wasted guard bands between SPS and the PDSCH or PUSCH.

A special slot structure is disclosed which includes a Sync Signal (SS), Physical Broadcast Channel (PBCH), Pilot Signals (PS), Guard Period (GP), and Physical Random Access Channel (PRACH) as will be described in detail. These slot-based features greatly simplify the LTE frame structure, reduce cost, and maintain compatibility with TD-LTE. The present invention advantageously employs a robust Forward Error Correction (FEC) method by concatenating turbo code as an inner code with a Reed Solomon outer block code providing a very low Block Error Rate (BLER). Moreover, embodiments of the present invention support carrier aggregation with up to four Component Carriers (CCs) per HU with dynamic scheduling of multiple RUs with one dynamic allocation per CC. These embodiments also support semi-persistent scheduling (SPS) of small allocations in Frequency Division Multiple Access (FDMA) within a slot for RUs destined to convey high priority traffic, thereby avoiding latency associated with Time Division Multiple Access (TDMA) of dynamic scheduling. This combination of TDMA dynamic scheduling and FDMA SPS provides optimum performance with minimal complexity.

There are several advantages to this type of dynamic allocation. Each RU receives the allocation information from the parent HU on the physical broadcast channel (PBCH). Each RU decodes this allocation information every 5 ms to find its potential slot(s) and component carrier(s). In this manner, every RU is aware of the dynamic slot allocation for every other RU served by the HU. Each RU then obtains procedural information on a physical downlink control channel (PDCCH) identified with the respective slot. In other words, the PDCCH provides procedural information such as modulation control scheme (MCS), precoding matrix indicator (PMI), and rate indicator (RI) without regard to which RU is the intended recipient of that slot. The benefit of this is that the PDCCH may be distributed to all DL slots and component carriers with a minimal size. Each PDCCH does not need to carry an index of the RU scheduled in its associated slot. Moreover, since all RU indices and component carriers are identified by the PBCH, receipt of all allocation information may be acknowledged by each RU with a single PBCH-ACK.

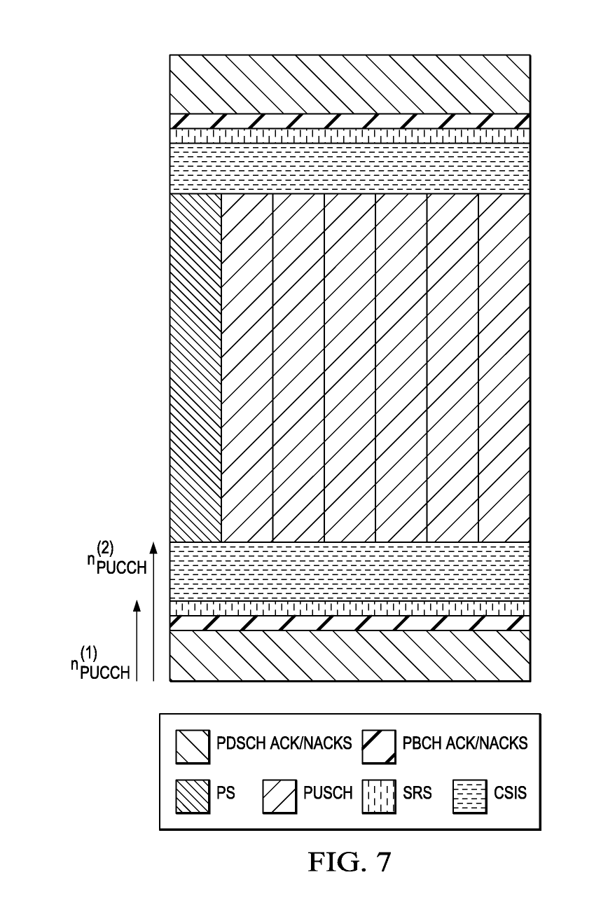

FIG. 7, there is a detailed diagram of the uplink slot that may be used with the frame of FIG. 5. UL slots are used for transmitting the Physical Uplink Shared Channel (PUSCH) conveying payload traffic to the HU from the RUs. The PUCCH provides the HU with HARQ ACK/NACK feedback from the RU. ACK/NACK bundling is needed in some configurations, and bundling must apply per RU. A direct consequence is that ACK/NACK mapping onto PUCCH resources group ACK/NACKs per RU. This assumes each RU is aware of all DL allocations of other RUs. For dynamic allocations, this is straightforward since each RU decodes all dynamic grants in the PBCH. For SPS allocations, this implies higher layers signal SPS allocations of all RUs to each RU. In case of ACK/NACK bundling, each RU is aware of the potential bundling factor applied to all other RUs, so each RU is aware of the total number NR (n_{RU}^{A/N}) (n_{RU}) of PDSCH ACK/NACKs (bundled or not) reported by any given RU with RU index n_{RU}. For each RU, the PDSCH ACK/NACKs to be transmitted in a PUCCH slot are first grouped in the time direction across multiple DL slots associated with the UL slot in chronological order. Then they are grouped in the frequency direction across secondary component carriers (CCs) first by decreasing CC index and then by primary CC last. In the primary CC they are grouped first across the dynamic allocation and then the SPS allocation. With dynamic scheduling, the RU decodes the PBCH every 5 ms to find its potential slot allocation information. Transmission over the PUSCH or reception over the PDSCH may be dynamically or semi-persistently scheduled (SPS) by the HU. Both PUSCH transmission and PDSCH reception are configured independently for each RU through higher layer signaling on the PDSCH. The SPS configuration includes frequency chunk(s) among four available SPS chunks per slot as well as a number of adjacent chunks used by a RU. Additional configuration information includes time slot(s) in each frame, period of the SPS allocation, modulation control scheme (MCS), transmission mode (TM), and SPS chunk size for DL.

PUCCH allocation size is mainly driven by PDSCH ACK/NACK allocation. For a given bandwidth, only a fixed number of physical resource blocks (PRBs) are available for PUCCH and PUSCH transmission. According to an embodiment of the present invention, a number of PUCCH PRBs is completely determined from the UL/DL frame configuration, the slot number, and the number of RUs supported by the HU. As a result, the PUCCH allocation size does not need to be explicitly signaled to the RUs. Each RU determines the PUCCH allocation size for each slot from the frame configuration and the total number of RUs.

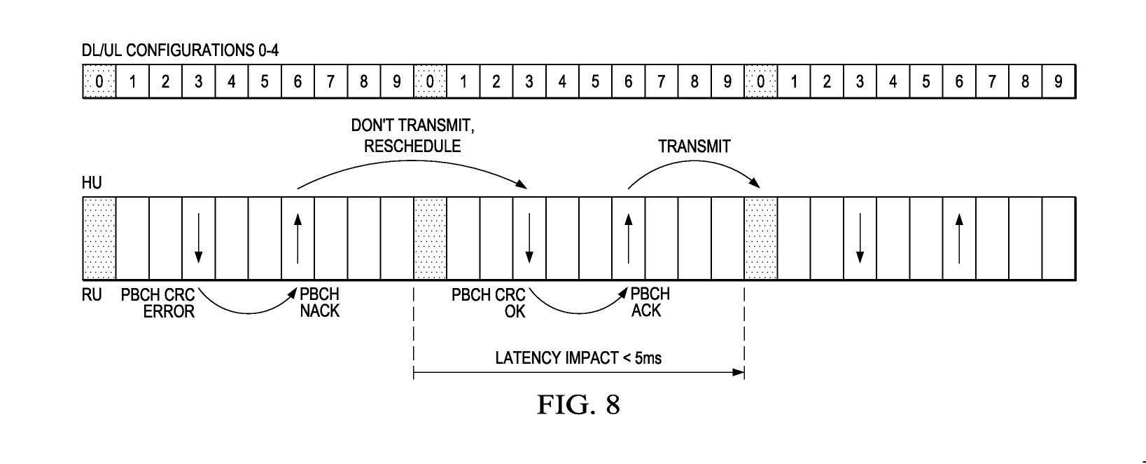

Referring now to FIG. 8, there is a diagram showing communication of system information and potential scheduling grants from a HU to a RU in a transport block (TB) over a physical broadcast channel (PBCH). The TB is transmitted to all RUs supported by the HU, but interaction between a single RU and the HU is illustrated by way of example. Three frames, each having ten 0.5 ms slots are shown in the upper part of the diagram for frame configurations 0-4. The lower part of the diagram illustrates communication between the HU and the RU with up arrows indicating an UL and down arrows indicating a DL. At slot 3 of the first frame, the RU receives the TB with a cyclic redundancy code (CRC) and determines there is a transmission error. In one embodiment of the present invention, the CRC is scrambled with a scrambling code associated with the antenna configuration. Responsively, the RU transmits a negative acknowledgement (NACK) to the HU in slot 6 of the first frame. The HU receives the NACK and reschedules the previous transmission in slot 3 of the second frame. The RU receives the TB and determines from the CRC that there is no transmission error. The RU then sends an acknowledgement (ACK) to the HU in slot 6 of the second frame. The HU receives the ACK and responsively schedules a next transmission to the RU in the third frame. The latency impact due to a transmission error, therefore, is no more than 5 ms due to the frame duration according to the present invention.

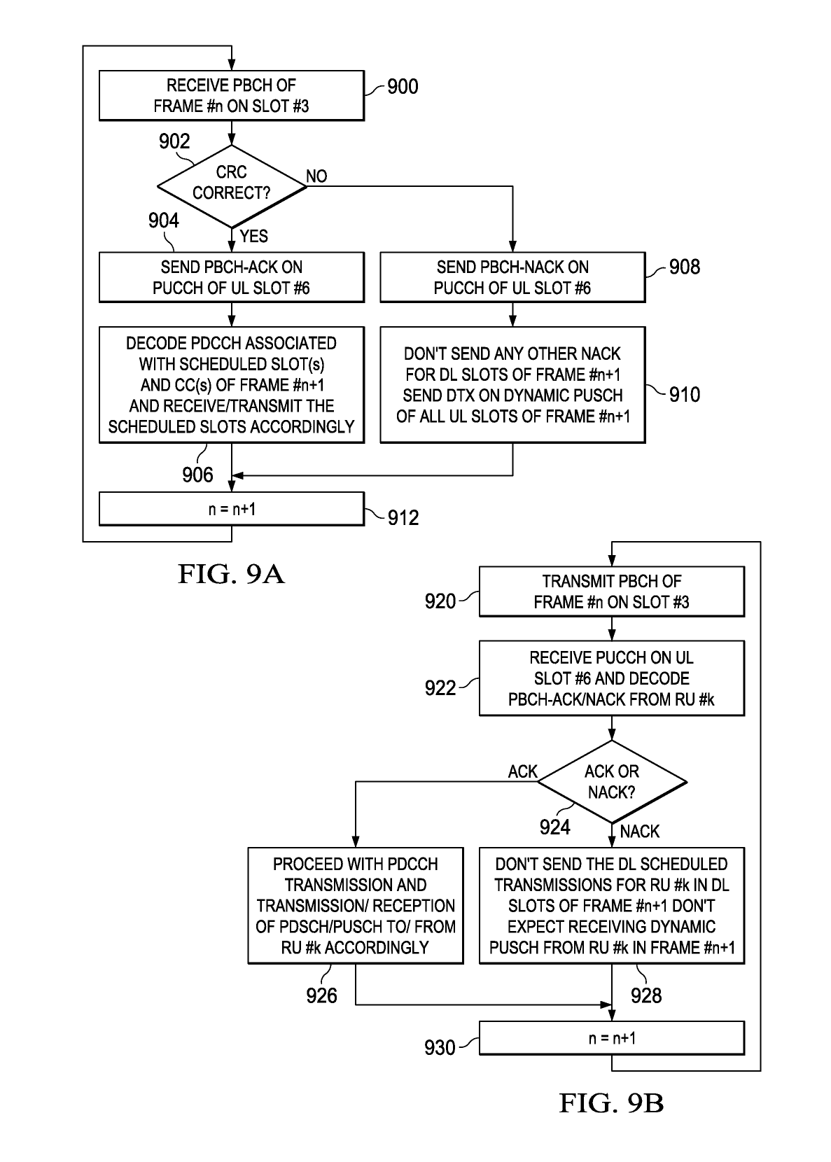

Referring now to FIGS. 9A and 9B, there are a flow diagrams showing physical broadcast channel (PBCH) operating procedure between the RU and HU. As in FIG. 8, the procedure begins at block 920 when the HU transmits the PBCH of frame #n on slot #3. RU #k receives the PBCH at block 900 and checks the CRC. If there is a CRC error at test 902, the RU transmits a PBCH NACK at block 908 of UL slot #6 of frame #n. At block 910 the RU does not send any other NACK for other DL slots of frame #n+1 and sends a discontinuous transmission (DTX) signal to the HU on the dynamic PUSCH of all UL slots of frame #n+1.

The HU receives the PUCCH from RU #k on UL slot #6 of frame #n at block 922 and decodes the PBCH. The HU determines the PBCH includes a NACK at test 924. The HU suspends scheduled DL transmissions for RU #k on frame #n+1 and does not expect a dynamic PUSCH from RU #k in frame #n+1. At block 930, the HU increments the frame index to #n+1 and control transfers to block 920. Here, the HU again transmits the PBCH of frame #n (now #n+1) on slot #3. RU #k receives the PBCH at block 900 and again checks the CRC. This time there is no CRC error at test 902, and the RU transmits a PBCH ACK at block 904 of UL slot #6 of frame #n.

The HU receives the PUCCH from RU #k on UL slot #6 of frame #n at block 922 and decodes the PBCH. The HU determines this PBCH includes an ACK at test 924. The HU proceeds with scheduled PDCCH transmission and transmission or reception of the respective PDSCH or PUSCH corresponding to RU #k. The RU decodes the received PDCCH associated with the scheduled slot(s) and CC(s) at block 906. At block 912 the RU increments the frame index and control returns to block 900 to receive the next PBCH. As previously mentioned, the latency impact due to a transmission error is advantageously no more than 5 ms due to the frame duration according to the present invention.

Still further, while numerous examples have thus been provided, one skilled in the art should recognize that various modifications, substitutions, or alterations may be made to the described embodiments while still falling with the inventive scope as defined by the following claims. Furthermore, embodiments of the present invention may be implemented in software, hardware, or a combination of both. Other combinations will be readily apparent to one of ordinary skill in the art having access to the instant specification.

What is claimed is:

1. A method of operating a wireless communication system, comprising:
receiving allocation information for a plurality of second wireless transceivers from a first wireless transceiver by one of the second wireless transceivers on a physical broadcast channel (PBCH);
decoding the allocation information for the plurality of second wireless transceivers by said one of the second wireless transceivers; and
receiving procedural information on a physical downlink control channel (PDCCH) in response to the decoded allocation information.

2. The method of claim 1, wherein the allocation information specifies which slots of a frame and component carriers are allocated to said one of the second wireless transceivers.

3. The method of claim 1, wherein the PBCH is transmitted in every frame and the PDCCH is transmitted in every downlink slot.

4. The method of claim 1, wherein the allocation information for each second wireless transceiver of the plurality of second wireless transceivers is independent of procedural information for other second wireless transceivers, and wherein each second wireless transceiver reads the allocation information for the plurality of second wireless transceivers.

5. The method of claim 1, wherein the PDCCH provides procedural information identified by allocation of a component carrier and a slot of a frame.

6. The method of claim 1, wherein the PDCCH provides procedural information of a component carrier and a slot of a frame used in a subsequent uplink transmission from said one of the second wireless transceivers.

7. The method of claim 1, comprising assigning a unique index from the first wireless transceiver to each second wireless transceiver, wherein a first index is reserved for random access communication.

8. The method of claim 1, comprising:
dynamically configuring a separate PDCCH in each downlink (DL) slot of a frame and component carrier; and
transmitting respective downlink control information (DCI) including a modulation and coding scheme (MCS) and transmission mode in a DL slot and component carrier to said one of the second wireless transceivers.

9. The method of claim 8, wherein the transmission mode is determined from a modulation code scheme (MCS) codeword.

10. The method of claim 1, comprising:
dynamically configuring a separate physical downlink control channel (PDCCH) in each downlink slot of a frame and component carrier; and
transmitting respective downlink control information (DCI) including a transmission mode used in a subsequent uplink transmission from said one of the second wireless transceivers.

11. A method of operating a first wireless transceiver:
determining a frame configuration, the frame having a plurality of slots;
determining a slot number of one of the plurality of slots;
determining a number of second wireless transceivers supported by the first wireless transceiver; and
allocating a physical uplink control channel (PUCCH) size in response to the frame configuration, the slot number, and the number of second wireless transceivers.

12. The method of claim 11, comprising receiving channel state information (CSI) from each of the second wireless transceivers, at least once every frame.

13. The method of claim 12, wherein the CSI includes channel quality information, a precoding matrix indicator, and rate information.

14. The method of claim 11, wherein the PUCCH includes one of an acknowledgement and negative acknowledgement for a previous physical downlink shared channel transmission.

15. The method of claim 11, wherein the PUCCH includes one of an acknowledgement and negative acknowledgement for a previous physical broadcast channel transmission.

16. A method of operating a first wireless transceiver, comprising:
transmitting system information in a transport block (TB) to a plurality of second wireless transceivers on a physical broadcast channel (PBCH);
transmitting at least one scheduling grant in the TB to the plurality of second wireless transceivers on the PBCH; and
receiving one of an acknowledgement (ACK) and negative acknowledgement (NACK) from each second wireless transceiver by the first wireless transceiver.

17. The method of claim 16, wherein said each second wireless transceiver decodes the PBCH in each received frame.

18. The method of claim 16, comprising sending back said one of an ACK and NACK on a physical uplink control channel (PUCCH).

19. The method of claim 16, comprising decoding a cyclic redundancy code (CRC) for the TB to determine said one of an ACK and NACK.

20. The method of claim 19, wherein the CRC is scrambled with a scrambling code associated with an antenna configuration.
